(19) United States
(12) Patent Application Publication
(10) Pub. No.: US 2014/0260444 A1
(43) Pub. Date: Sep. 18, 2014

(54) FILE CABINET DRAWER LOCKING DEVICE

(71) Applicants: Albert Long TRINH, Maineville, OH (US); Dennis Sam Trinh, Maineville, OH (US); Toan Trinh, Maineville, OH (US)

(72) Inventors: Albert Long TRINH, Maineville, OH (US); Dennis Sam Trinh, Maineville, OH (US); Toan Trinh, Maineville, OH (US)

(21) Appl. No.: 13/843,847

(22) Filed: Mar. 15, 2013

(51) Int. Cl. E05B 65/46

(52) U.S. Cl. CPC E05B 65/46
USPC 70/78

(57) ABSTRACT

A locking system for standard file drawer cabinets, and in particular steel-constructed filing cabinets. The system includes a first locking device including a main elongated member that includes a locking end portion and an opposing attaching end portion, the attaching end portion including an upturned wall at the distal end of the attaching end, and a laterally-extending hooking member extending from an upper end of the upturned wall toward the locking end portion, substantially parallel to the main elongated member, the hooking member spaced apart from the main elongated member at the attaching end by a gap having a dimension, wherein the gap accommodates insertion of the thickness of an inwardly extending wall of a filing cabinet that defines the upper edge of the file drawer opening.

### FIELD OF THE INVENTION

The present invention relates generally to a locking device for drawers of a file cabinet.

### BACKGROUND OF THE INVENTION

Lower-priced file cabinets are commonly sold without a built-in lock. Some other cabinets may originally have a built-in lock, but the keys may be malfunctioning or the key may be lost. In these cases, a replacement lock provided by a locksmith may be expensive. It is desirable to have an inexpensive non-built-in locking device to lock a drawer of the file cabinet, in order to store and secure valuable, sensitive or confidential documents.

### SUMMARY OF THE INVENTION

The present invention provides a locking system for standard file drawer cabinets, and in particular steel-constructed filing cabinets. The system includes a first locking device including a main elongated member that includes a locking end portion and an opposing attaching end portion, the attaching end portion including an upturned wall at the distal end of the attaching end, and a laterally-extending hooking member extending from an upper end of the upturned wall toward the locking end portion, substantially parallel to the main elongated member, the hooking member spaced apart from the main elongated member at the attaching end by a gap having a dimension, wherein the gap accommodates insertion of the thickness of an inwardly extending wall of a filing cabinet that defines the upper edge of the file drawer opening.

The first locking device is useful in locking the drawer, especially the top drawer, of a first embodiment of a filing cabinet that includes a main drawer disposed within a main drawer frame, the upper structure of main drawer frame defining a drawer opening including a vertical outer wall having a lower edge and a lower horizontal wall of a wall thickness extending perpendicularly from the lower edge into the drawer opening.

The attaching end can include a laterally-extending upturned wall and an upper and lower laterally-extending members extending from a lower end and the upper end of the upturned wall, toward the locking end, the upper and lower laterally-extending members having a substantially constant gap therebetween that accommodates insertion of the thickness of the lateral lower horizontal wall of the drawer opening with the elongated member extending outward from the drawer opening. The gap between the pair of laterally-extending members can taper toward the locking end, with the upper laterally-extending member having an upturned distal edge for easier insertion of the lateral lower horizontal wall of the drawer opening.

The invention also relates to a method for securing closed a drawer within a drawer opening of a file cabinet, comprising the steps of: a) opening a drawer of a file cabinet; b) attaching the attaching end portion of the locking device to the lower horizontal portion of the upper front of the file cabinet; c) closing the drawer to expose the locking end portion; and d) attaching a lock to the locking end portion to prevent the drawer from opening within the drawer opening.

The invention also relates to instructions associated with the use of the locking device with a file cabinet, directing the consumer to attach the locking device to the file cabinet, and for closing and locking the drawer in the file cabinet. The invention also relates to a method of closing and locking and securing a drawer of a file cabinet using the locking device.

The invention also relates to an article of manufacture comprising the locking device, packaged in association with instructions for use by a consumer, with the use of the locking device with a file cabinet, and with a method of locking and securing a drawer of the file cabinet using the locking device.

### BRIEF DESCRIPTION OF THE FIGURES

FIG. 1 shows a first embodiment of a locking device of the invention.

FIG. 2 shows a side elevation view of the locking device of FIG. 1.

FIG. 3 shows a perspective view of the locking device being inserted through the drawer opening of a filing cabinet.

FIG. 4 shows a side view of the FIG. 3.

FIG. 5 shows the locking device attached to a wall of the drawer opening, with the file drawer closed and a locking means attached to the locking device to secure the drawer in the closed position.

### DETAILED DESCRIPTION OF THE INVENTION

FIG. 1 shows a locking device 10 having a attaching end 12 and an locking end portion 14. An elongated planar body 16 joins, and provides a portion of the locking end 14 and the attaching end 12. An upturned wall 18 at the distal end of the attaching end 12 connects to a laterally-extending hooking member 20 that extends from an upper end of the upturned wall 18 toward the locking end 14. The hooking member 20 is substantially planar and substantially parallel to the body 16 of the extending member. The spacing of the gap G separating the hooking member 20 from the body 16 of the main elongated member has a dimension that accommodates insertion of the thickness 102 of an inwardly extending wall 103, shown in FIG. 3, of a filing cabinet that defines the upper edge of the file drawer opening.

The locking end 14 comprises a rounded end 52 and a plurality of lock engaging elements 50 (teeth or ridges) disposed along the side edge of the body 16. This locking end 14 is used to lock the drawer using a ratcheting lock 55 (shown in FIG. 5 with a partial cutaway to show the teeth 50) having a body with a transverse slot 58 which is of a size suitable to slidably receive the locking end portion 14 to secure closed the drawer.

The first locking device is useful in locking the drawer of a first embodiment of a filing cabinet shown in FIGS. 3 and 5 that includes a main drawer 101 disposed within a main drawer frame 100, the upper structure of main drawer frame defining a drawer opening including a vertical outer wall having a lower edge and a lower horizontal wall 103 of a wall thickness 102 extending perpendicularly from the lower edge into the drawer opening.

The upturned wall 18 is also illustrated as being laterally-extending, and connects the upper laterally-extending or hooking member 20 with a lower laterally-extending member 22. The upper and lower laterally-extending members 20 and 22 having a substantially constant gap therebetween that accommodates insertion of the thickness of the lateral lower horizontal wall 103 of the drawer opening with the body 16 of the elongated locking portion 14 extending outward from the drawer opening. The gap between the pair of laterally-extending members of the attaching portion 12 can have a taper 26 toward the locking end of dimension X. The upper laterally-extending member 20 can have an upturned distal edge 28 for easier insertion of the lateral lower horizontal wall 103 of the drawer opening.

FIG. 2 shows a side elevation view of the locking device of FIG. 1 and defines the working dimensions of the attaching end portion 12. The gap A is typically from 0.8 to about 1.5 mm, preferably from 0.9 to about 1.1 mm. The gap B at the tip 28 of the hooking member 20 should be wide enough to easily insert the lateral lower horizontal wall 103, with typically B being from about 0.7 mm to about 1.4 mm, preferably from about 0.8 mm to about 1.0 mm. The narrow gap X is preferably smaller than gap B, preferably less than about 0.7 mm, more preferably less than about 0.6 mm, and even more preferably from 0 mm to about 0.3 mm, in order for the attaching end portion to firmly grasping the lateral lower horizontal wall 103, thus allowing an easy insertion of the protruding locking end portion 14 into the slot 58 of the ratcheting lock 55 once the drawer is in the close position.

Once the locking device is installed by hooking the attaching end 12 over the horizontal wall 103 of the drawer, the file drawer 101 is closed and a lock means, illustrated as a ratcheting lock 55, is installed over the rounded end 52 of the locking end to engage ratchetingly to the teeth 50 along the side edge of the body 16, thereby securing closed the drawer 101.

The length of the pair of laterally-extending members of the attaching portion 12 that extend along the lower horizontal portion 103 of the file cabinet is typically from about 6 cm to about 12 cm, preferably from about 8 cm to about 10 cm. The narrow gap formed between the lower horizontal portion 103 of the upper front of the file cabinet and the upper horizontal edge 109 of the cabinet drawer constrains the attaching end of the elongated member and prevents the elongated member from wiggling.

The invention also relates to instructions associated with the use of the locking device with a file cabinet, directing the consumer to attach the locking device to the file cabinet, and for closing and locking the drawer in the file cabinet. The invention also relates to a method of closing and locking and securing a drawer of a file cabinet using the locking device. Typically the method for securing closed a drawer within a drawer opening of a file cabinet comprises the steps of: a) opening a drawer of a file cabinet; b) attaching the attaching end portion of the locking device to the lower horizontal portion of the upper front of the file cabinet; c) closing the drawer to expose the locking end portion; and e) attaching a locking means to the locking end portion to prevent the drawer from opening within the drawer opening.

The invention also relates to an article of manufacture comprising the locking device, the lock and one or more keys, packaged in association with instructions for use by a consumer, with the use of the locking device with a file cabinet, and with a method of locking and securing a drawer of the file cabinet using the locking device.

We claim:

1. A locking system for standard file drawer cabinets, and in particular steel-constructed filing cabinets, including a locking device including a main elongated body that includes a locking end and an opposing attaching end, the attaching end including an upturned wall at the distal end of the attaching end, and a laterally-extending hooking member extending from an upper end of the upturned wall toward the locking end, substantially parallel to the main elongated member, the hooking member spaced apart from the main elongated member at the attaching end by a gap having a dimension, wherein the gap accommodates insertion of a thickness of an inwardly extending wall of a filing cabinet that defines an upper edge of a file drawer opening.

2. The locking system of claim 1, wherein the locking end including a plurality of teeth along an edge of the body, and further including a locking means comprising a ratcheting lock to engage ratchetingly the teeth to secure the locking means to the locking end of the device.

3. The locking system of claim 1, wherein the attaching end includes a laterally-extending upturned wall, and further including a lower laterally-extending member extending from a lower end of the upturned wall, wherein the lower laterally-extending member and the laterally-extending hooking member having a substantially constant gap therebetween that accommodates insertion of the thickness of the lateral lower horizontal wall of the drawer opening with the elongated member extending outward from the drawer opening.

4. The locking system of claim 1, wherein the gap between the lower laterally-extending member and the laterally-extending hooking member tapers toward the locking end.

5. The locking system of claim 1, wherein the upper laterally-extending member has an upturned distal edge for easier insertion of the lateral lower horizontal wall of the drawer opening.

6. A method for securing closed a drawer within a drawer opening of a file cabinet, comprising the steps of:
a) opening a drawer of a file cabinet;
b) attaching the attaching end portion of the locking device to the lower horizontal portion of the upper front of the file cabinet;
c) closing the drawer to expose the locking end portion; and
d) attaching a lock to the locking end portion to prevent the drawer from opening within the drawer opening.

7. The method according to claim 6 wherein the locking end portion includes a plurality of lock engaging teeth along at least one side edge, and the locking means is a ratcheting display lock.

8. An article of manufacture comprising:
a) a locking device also including a lock and one or more keys,
b) packaged in association with instructions for use by a consumer of the locking device with furniture, for locking and securing a drawer of the file cabinet using the locking device.

9. The article of manufacture according to claim 8, wherein the instructions direct the consumer to attach the locking device to the file cabinet, and for closing and locking the drawer in the file cabinet.
